(19) United States
(12) Patent Application Publication
(10) Pub. No.: US 2026/0012982 A1
(43) Pub. Date: Jan. 8, 2026

(54) RANDOM ACCESS IN WIRELESS COMMUNICATION SYSTEM

(71) Applicant: Samsung Electronics Co., Ltd., Suwon-si (KR)

(72) Inventors: Anil Agiwal, McKinney, TX (US); Kyeongin Jeong, Frisco, TX (US); Shiyang Leng, Little Elm, TX (US)

(21) Appl. No.: 19/242,964

(22) Filed: Jun. 18, 2025

Related U.S. Application Data
(60) Provisional application No. 63/668,686, filed on Jul. 8, 2024.
(60) Provisional application No. 63/670,567, filed on Jul. 12, 2024.
(60) Provisional application No. 63/692,401, filed on Sep. 9, 2024.

(51) Int. Cl. H04W 74/0833; H04W 74/00

(52) U.S. Cl. CPC H04W 74/0833; H04W 74/006

(57) ABSTRACT

A user equipment (UE) includes a transceiver configured to receive, from a base station (BS), a plurality of random access (RA) resource configurations. The UE also includes a processor operably coupled to the transceiver. The processor is configured to initiate an RA procedure, select an RA resource configuration from the plurality of RA resource configurations for the RA procedure, and cause the transceiver to transmit an indication of the selected RA resource configuration to the BS. The processor is also configured to, after causing the transceiver to transmit the indication of the selected RA resource configuration to the BS, perform the RA procedure based on the selected RA resource configuration.

### CROSS-REFERENCE TO RELATED APPLICATIONS AND CLAIM OF PRIORITY

This application claims priority under 35 U.S.C. § 119(e) to U.S. Provisional Patent Application No. 63/668,686 filed on Jul. 8, 2024, U.S. Provisional Patent Application No. 63/670,567 filed on Jul. 12, 2024, and U.S. Provisional Patent Application No. 63/692,401 filed on Sep. 9, 2024. The above-identified provisional patent applications are hereby incorporated by reference in their entirety.

### TECHNICAL FIELD

This disclosure relates generally to wireless networks. More specifically, this disclosure relates to random access in a wireless communication system.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for random access in a wireless communication system.

In one embodiment, a user equipment (UE) is provided. The UE includes a transceiver configured to receive, from a base station (BS), a plurality of random access (RA) resource configurations. The UE also includes a processor operably coupled to the transceiver. The processor is configured to initiate an RA procedure, select an RA resource configuration from the plurality of RA resource configurations for the RA procedure, and cause the transceiver to transmit an indication of the selected RA resource configuration to the BS. The processor is also configured to, after causing the transceiver to transmit the indication of the selected RA resource configuration to the BS, perform the RA procedure based on the selected RA resource configuration.

In another embodiment, a BS is provided. The BS includes a transceiver configured to transmit, to a UE, a plurality of RA resource configurations, and receive from the UE, an indication of an RA resource configuration selected by the UE from the plurality of RA resource configurations. The BS also includes a processor operably coupled to the transceiver. The processor is configured to, after receiving the indication of the selected RA resource configuration from the UE, perform an RA procedure with the UE based on the selected RA resource configuration.

In yet another embodiment, a method of operating a UE is provided. The method includes receiving, from a BS, a plurality of RA resource configurations, initiating an RA procedure, and selecting an RA resource configuration from the plurality of RA resource configurations for the RA procedure. The method also includes transmitting an indication of the selected RA resource configuration to the BS, and after transmitting the indication of the selected RA resource configuration to the BS, performing the RA procedure based on the selected RA resource configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for random access according to embodiments of the present disclosure;

FIG. 5 illustrates an example of usage of indicating a selected random access configuration or a set of RACH resources to the network according to embodiments of the present disclosure;

FIG. 6 illustrates another example procedure for random access according to embodiments of the present disclosure;

FIGS. 7A-7B illustrate another example procedure for random access according to embodiments of the present disclosure;

FIG. 8 illustrates an example procedure for 2 step random access according to embodiments of the present disclosure;

FIG. 9 illustrates an example procedure for 4 step random access according to embodiments of the present disclosure;

FIG. 10 illustrates an example method for random access according to embodiments of the present disclosure; and

FIG. 11 illustrates an example method for random access according to embodiments of the present disclosure.

### DETAILED DESCRIPTION

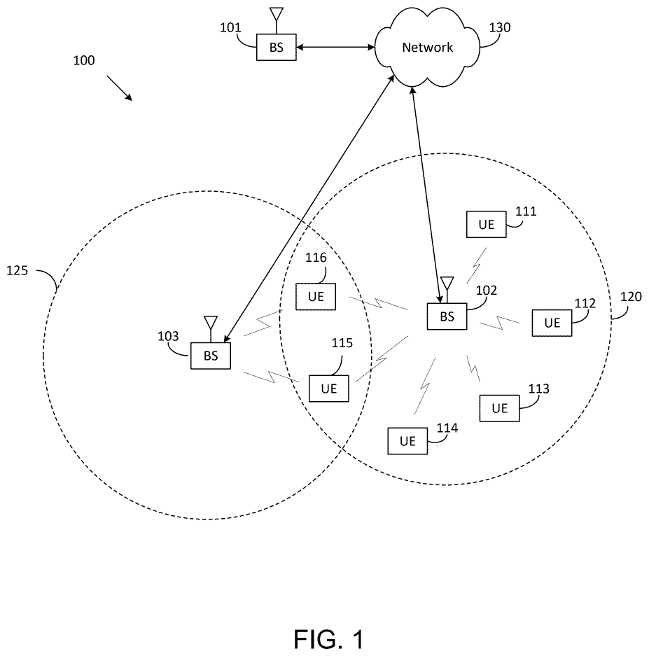

FIGS. 1 through 11, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device.”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for random access in a wireless communication system. In certain embodiments, one or more of the gNBs 101-103 includes circuitry, programing, or a combination thereof, to support random access in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

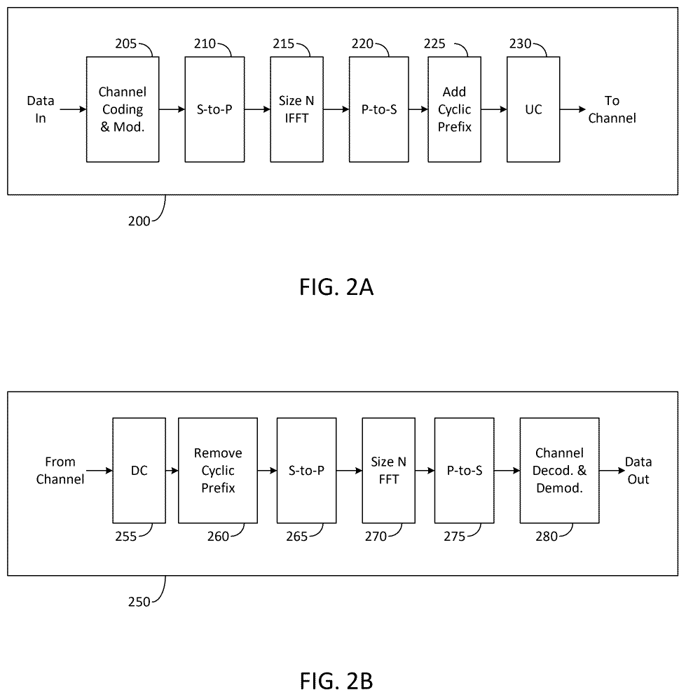

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support random access in a wireless communication system as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols.

The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

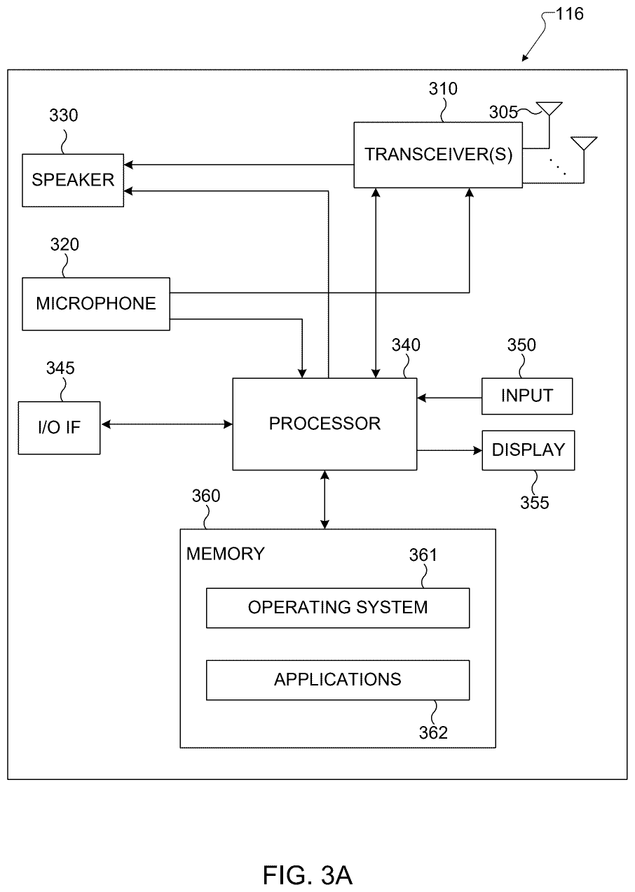

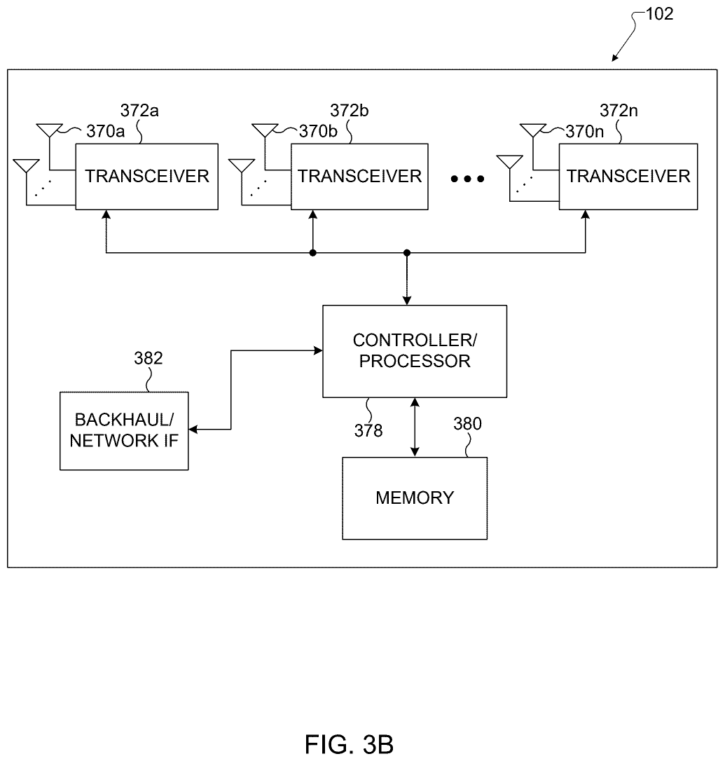

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for random access in a wireless communication system as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support random access in a wireless communication system as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or positioning SIBs (posSIBs) having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RR (Reconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

$$( y * number of slots in a radio frame ) + x - \text{Monitoring-offset-} PDCCH \text{-slot} ) mod ( \text{Monitoring-periodicity-} PDCCH \text{-slot} ) = 0.$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SC). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-Inactivity Timer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in an RRC CONNECTED state. Several types of RA procedures are supported, such as contention based random access, and contention free random access. Each of these can be one of 2 step or 4 step random access.

In contention based random access (CBRA), also referred to as 4 step CBRA, the UE first transmits a random access preamble (also referred to as a Msg1) and then waits for a random access response (RAR) in the RAR window. The RAR is also referred to as a Msg2. The gNB transmits the RAR on a PDSCH. A PDCCH scheduling the PDSCH carrying the RAR is addressed to an RA-radio network temporary identifier (RA-RNTI). The RA-RNTI identifies the time-frequency resource (also referred to as a physical RA channel [PRACH] occasion or PRACH TX occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first OFDM symbol of the PRACH occasion where the UE has transmitted the Msg1 (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for the Msg1 transmission (0 for the NUL carrier and 1 for the SUL carrier). Several RARs for various Random-access preambles detected by the gNB can be multiplexed in the same RAR media access control (MAC) protocol data unit (PDU) by gNB. A RAR in a MAC PDU corresponds to the UE's RA preamble transmission if the RAR includes an RA preamble identifier (RAPID) of RA preamble transmitted by the UE. If the RAR corresponding to the UE's RA preamble transmission is not received during the RAR window and the UE has not yet transmitted the RA preamble for a configurable (configured by the gNB in a RACH configuration) number of times, the UE goes back to the first step (i.e., the UE selects a random access resource [preamble/RACH occasion] and transmits the RA preamble). A backoff may be applied before going back to first step.

If the RAR corresponding to the UE's RA preamble transmission is received the UE transmits a Msg3 in the UL grant received in the RAR. The Msg3 includes a message such as an RRC connection request, RRC connection re-establishment request, RRC handover confirm, scheduling request, SI request etc. The Msg3 may include the UE identity (i.e., cell-radio network temporary identifier [C-RNTI] or system architecture evolution [SAE]-temporary mobile subscriber identity [S-TMSI] or a random number). After transmitting the Msg3, The UE starts a contention resolution timer. While the contention resolution timer is running, if the UE receives a PDCCH addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (the first X bits of a common control channel [CCCH] service data unit [SDU] transmitted in the Msg3), contention resolution is considered successful, the contention resolution timer is stopped, and the RA procedure is completed. If the contention resolution timer expires and the UE has not yet transmitted the RA preamble for a configurable number of times, the UE goes back to the first step (i.e., the UE selects a random access resource [preamble/RACH occasion] and transmits the RA preamble). A backoff may be applied before going back to first step.

For performing CBRA, a RACH configuration is signaled in system information (i.e., SIB 1) and in dedicated RRC signaling. The RACH configuration in SIB 1 is used by the UE in RRC IDLE and RRC INACTIVE states.

The contention based RACH configuration includes prach-ConfigurationIndex which indicates the available set of PRACH occasions for the transmission of the random access preamble. The number of PRACH occasions in the PRACH configuration period is pre-defined for each PRACH configuration index. The PRACH configuration period for each PRACH configuration index is also pre-defined. A pre-defined PRACH configuration table lists a number of configurations, wherein each configuration indicates the number of PRACH occasions in the PRACH configuration period, the PRACH configuration period, the location of PRACH occasions in the PRACH configuration period, etc. The PRACH configuration index is an index to an entry in this PRACH configuration table.

The contention based RACH configuration also includes ssb-perRACH-OccasionAndCB-PreamblesPerSSB. ssb-perRACH-OccasionAndCB-PreamblesPerSSB indicates CB-PreamblesPerSSB (R) and ssb-perRACH-Occasion (N).

Based on ssb-perRACH-Occasion and the number of SSBs transmitted in cell, PRACH occasions configured by prach-ConfigurationIndex are mapped to SSBs. The number of SSBs transmitted in the cell is signaled by the gNB in system information and dedicated RRC signaling messages. PRACH occasions are mapped to SSBs over an association period. The association period starting from SFN 0 is the period in which all SSBs are mapped to PRACH occasions at least once. In an example, the association period can be equal to {1, 2, 4, 8, 16} PRACH Configuration periods.

If N<1, one SSB is mapped to 1/N consecutive valid PRACH occasions and R contention based preambles with consecutive indexes associated with the SSB per valid PRACH occasion start from preamble index 0. If N≥1, R contention based preambles with consecutive indexes associated with SSB n, 0≤n≤N−1, per valid PRACH occasion start from preamble index

$$n \cdot {N}_{preamble}^{total} / N where {N}_{preamble}^{total}$$

is provided by totalNumberOfRA-Preambles and is an integer multiple of N. totalNumberOfRA-Preambles is signaled by gNB in RACH configuration.

Contention free random access (CFRA), also referred to as legacy CFRA or 4 step CFRA, is used for scenarios such as handover where low latency is required, timing advance establishment for secondary cell (Scell), etc. An Evolved node B (eNB) assigns to the UE a dedicated random access preamble. The UE transmits the dedicated RA preamble. The eNB transmits the RAR on a PDSCH addressed to an RA-RNTI. The RAR conveys the RA preamble identifier and timing alignment information. The RAR may also include an UL grant. The RAR is transmitted in a RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to a C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

In existing wireless networks, several RACH configurations or sets of RACH resources are configured to support various features (e.g., small data transmission [SDT], reduced capability [RedCap], enhanced RedCap [eRedCap], Msg1 repetitions, Msg3 repetitions, slicing, early SRS/CSI, etc.) and feature combinations. A set of RACH resources or a RACH configuration associated with a feature is only valid for random access procedures applicable to at least that feature, and a set of RACH resources or a RACH configuration associated with several features is only valid for random access procedures having at least all of these features. The UE selects the set of applicable RACH resources or a RACH configuration, after uplink carrier (i.e., NUL or SUL) and BWP selection and before selecting the RA type.

This leads to a significant amount of RACH resources being reserved which are not used all the time. In existing wireless networks, up to 32 RACH configurations or sets of RACH resources can be configured simultaneously in a BWP and several BWPs can be configured in the cell. Various embodiments of the present disclosure provide for more efficient utilization of RACH resources.

In existing wireless networks, during a 2 step random access, the UE transmits a MsgA (i.e., a PRACH preamble) and a MsgA MAC PDU to the network (e.g., a base station, node B, gNB, DU etc.). Upon receiving the MsgA, the network transmits a MsgB MAC PDU to the UE. The MsgA MAC PDU includes a successRAR MAC subPDU and may include a MAC subPDU for the UE's dedicated logical channel/signaling radio bearer/data radio bearer. The MAC subPDU for the UE's dedicated logical channel/signaling radio bearer/data radio bearer may include an RRC message in response to the RRC message included in the MsgA MAC PDU. For transmitting the MsgB, the network is not aware of the cell quality observed by the UE or CQI to determine the MCS and TB size for the MsgB. Therefore, the network transmits the MsgB using a robust modulation and coding scheme (MCS) (i.e., the lowest order modulation and very high coding rate) which may utilize more radio resources than actually necessary if the network was informed about the cell quality observed by the UE. Various embodiments of the present disclosure provide mechanisms to inform the network about the cell quality observed by the UE before the network transmits a MsgB.

In existing wireless networks, for a random access procedure, the total available preambles are divided into CFRA and CBRA preambles. CBRA preambles are further divided per SSB amongst SSBs mapped to one RACH occasion (RO) (which may also be referred to herein as a random access occasion). One RO can be mapped to several SSBs. CBRA preambles per SSB are then divided into group A and group B preambles, resulting in a small number of preambles per group per SSB in each RO. This may result in more contention if several UEs initiate random access before an RO. Various embodiments of the present disclosure provide mechanisms to reduce contention when several UEs initiate random access before an RO.

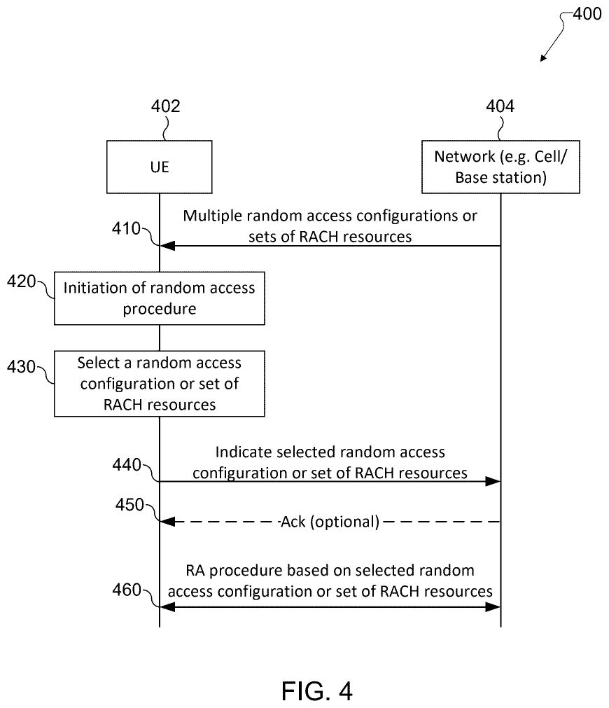

FIG. 4 illustrates an example procedure 400 for random access according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for random access could be used without departing from the scope of this disclosure.

In the example of FIG. 4, procedure 400 begins at operation 410. At operation 410, a UE 402 (which may be similar or identical to UE 116 of FIG. 1) may receive one or more random access configurations or sets of RA (or RACH) resources from network 404 (e.g., a base station or node B or DU or CU, etc.). These random access configurations or sets of RA (or RACH) resources can be received for one or more cells (or TRPs), and each cell/TRP can be a serving cell/TRP or non-serving cell/TRP. These random access configurations or sets of RA (or RACH) resources can be received in system information or an RRC message (common or dedicated).

In some embodiments, each random access configuration or set of RA (or RACH) resources may include parameters indicating random access preambles and random access occasions (ROs). In some embodiments, each random access configuration or set of RA (or RACH) resources may include a parameter indicating association between preambles and beams/SSBs (such as preambles per beam/SSB), association between random access occasions and beams/SSBs (such as beams/SSBs per random access occasion), parameter(s) configuring a random access response window and random access response search space, power ramping/control parameters etc. In some embodiments, different random access configurations or sets of RA (or RACH) resources may have their own random access parameters such as parameter(s) to indicate ROs, parameter(s) to indicate preambles, starting preamble index, parameter(s) to indicate preamble to SSB mapping, parameter(s) to indicate RO to SSB mapping, preamble group configuration, RSRP threshold for SSB selection, Msg1 subcarrier spacing, RAR window size, contention resolution timer, RSRP threshold for SSB selection, RSRP threshold for SUL selection, RA prioritisation parameters, power ramping parameters, maximum preamble transmission, etc. In some embodiments, the random access configuration or set of RA (or RACH) resources may share some random access parameters with other random access configurations or sets of RA (or RACH) resources and some random access parameters are not shared. In some embodiments, the random access configuration or set of RA (or RACH) resources may share some random access parameters with other random access configurations or sets of RA (or RACH) resources such as parameter(s) to indicate RO, parameter(s) to indicate RO to SSB mapping, Msg1 subcarrier spacing, RAR window size, contention resolution timer, RSRP threshold for SUL selection, RA prioritisation parameters, power ramping parameters, maximum preamble transmission, RA prioritisation parameters and have its own random access parameters such as parameter(s) to indicate preambles, starting preamble index, parameter(s) to indicate preamble to SSB mapping, preamble group configuration, RSRP threshold for SSB selection, etc.

In some embodiments, one or more random access configurations or sets of RA (or RACH) resources from network 404 can be received separately for each uplink carrier (SUL, NUL).

In some embodiments, one or more random access configurations or sets of RA (or RACH) resources from network 404 can be per BWP (or per BWP per uplink carrier[SUL, NUL]). Note that the uplink carrier can be configured with one or more BWPs.

In some embodiments, the random access configuration or set of RA (or RACH) resources is associated with one or more features (e.g., SDT, RedCap, eRedCap, Msg1 repetitions, Msg3 repetitions, slicing, coverage enhancements, early SRS/CSI etc.). In some embodiments, a random access configuration or set of RA (or RACH) resources may be associated with no feature.

In some embodiments, UE 402 may receive a configuration indicating resources (e.g., time, frequency, sequence, etc.) to indicate the selected random access configuration or set of RACH resources for the random access procedure. This configuration can be received in system information or an RRC message (common or dedicated). This configuration can be received for one or more cells. This configuration can be per BWP (or per BWP per UL carrier for a cell configured with BWP[s] and UL carrier[s]) for a cell configured with BWP(s). This configuration can be received for each random access configuration or set of RACH resources associated with one or more features. This configuration can be received for one or more random access configurations or sets of RACH resources associated with one or more features. If the configuration indicating the resources (e.g., time, frequency, sequence, etc.) to indicate the selected random access configuration or set of RACH resources for a random access procedure is received for a random access configuration or set of RACH resources for the random access procedure, the UE indicates the selection of that random access configuration or set of RACH resources for the random access procedure using the received configuration. For example, four random access configurations or 4 sets of RACH resources may be configured. A configuration to indicate the selected random access configuration or set of RACH resources is only provided for the 1^{st} and 2^{nd} random access configuration or the 1^{st} and 2^{nd} set of RACH resources. If the UE selects the 1^{st}/2^{nd} random access configuration or the 1^{st}/2^{nd} set of RACH resources at the initiation of random access procedure, the UE indicates the selected random access configuration or set of RACH resources using the received configuration to indicate the selected random access configuration or set of RACH resources. If the UE selects the 3^{rd}/4^{th} random access configuration or 3^{rd}/4^{th} set of RACH resources at the initiation of random access procedure, the UE does not indicate the selected random access configuration or set of RACH resources.

In some embodiments, resource(s) to indicate the selected random access configuration or set of RACH resources for a random access procedure can be a random access preamble and/or random access occasion and/or PUSCH occasion, wherein the random access preamble and/or random access occasion and/or PUSCH occasion for the indication can be separately configured for indicating selection of each random access configuration or set of RACH resources. For example, assume there are two random access configurations or sets of RACH resources. In some embodiments, one preamble (e.g., “Preamble A”) can be reserved/configured to indicate selection of a random access configuration/set of RACH resources “1” and another preamble (e.g., “Preamble B”) can be reserved/configured to indicate selection of a random access configuration/set of RACH resources “2”. In some embodiments, multiple preambles can be reserved/configured to indicate selection of random access configuration/set of RACH resources 1, wherein the preamble is associated with an SSB. In some embodiments, multiple preambles can be reserved/configured to indicate selection of random access configuration/set of RACH resources 2, wherein each preamble is associated with an SSB. ROs for indicating selection of the random access configuration/set of RACH resources can be configured by network 404. In these embodiments, UE 402 transmits the preamble for indicating selection of the random access configuration/set of RACH resources in one of these ROs. In case multiple preambles are reserved/configured to indicate selection of the random access configuration, UE 402 selects an SSB and then selects the preamble from multiple preambles corresponding to the selected SSB. In some embodiments, one preamble (e.g., Preamble A) can be reserved/configured to indicate selection of random access configuration/set of RACH resources 1 and random access configuration/set of RACH resources 2. ROs for indicating selection of the random access configuration/set of RACH resources can be configured by network 404. Separate ROs amongst these ROs can be indicated for random access configuration/set of RACH resources 1 and random access configuration/set of RACH resources 2. UE 402 transmits the preamble A for indicating selection of random access configuration/set of RACH resources 1 in an RO for random access configuration/set of RACH resources 1. UE 402 transmit the preamble A for indicating selection of random access configuration/set of RACH resources 2 in an RO for random access configuration/set of RACH resources 2. In some embodiments, multiple ROs can be reserved to indicate selection of random access configuration/set of RACH resources 1, wherein each RO is associated with one or more SSBs. In some embodiments, multiple ROs can be reserved to indicate selection of random access configuration/set of RACH resources 2, wherein each RO is associated with one or more SSBs. In case multiple ROs are reserved/configured to indicate selection of a random access configuration/set of RACH resources, UE 402 selects an SSB and then selects an RO from multiple ROs corresponding to the selected SSB. In some embodiments, one preamble (e.g., Preamble A) can be reserved/configured to indicate selection of random access configuration/set of RACH resources 1 and another preamble (e.g., Preamble B) can be reserved/configured to indicate selection of random access configuration/set of RACH resources 2. ROs for indicating selection of the random access configuration/set of RACH resources can be configured by network 404. Separate ROs amongst these ROs can be indicated for random access configuration/set of RACH resources 1 and random access configuration/set of RACH resources 2. UE 402 transmits the preamble A for indicating selection of random access configuration/set of RACH resources 1 in an RO for random access configuration/set of RACH resources 1. UE 402 transmits the preamble B for indicating selection of random access configuration/set of RACH resources 2 in an RO for random access configuration/set of RACH resources 2. In some embodiments one preamble (e.g., Preamble A) can be reserved/configured to indicate selection of the random access configuration/set of RACH resources 1 and random access configuration/set of RACH resources 2. A PUSCH occasion for a MsgA MAC PDU is also configured. UE 402 transmits preamble A and transmits the MsgA MAC PDU in the PUSCH occasion, wherein the MsgA MAC PDU indicates whether UE 402 has selected random access configuration/set of RACH resources 1 or random access configuration/set of RACH resources 2.

In some embodiments, if a resource to indicate the selected random access configuration or set of RACH resources for the random access procedure is not received, UE 402 may not indicate the selection of that random access configuration or set of RACH resources for the random access procedure. Alternately, in some embodiments, if a resource to indicate the selected random access configuration or set of RACH resources for the random access procedure is not received, UE 402 may use the default configuration (pre-defined/preconfigured) to indicate the selection of that random access configuration or set of RACH resources for the random access procedure.

In some embodiments, the resource to indicate the selected random access configuration or set of RACH resources for the random access procedure can be PUCCH resources, wherein the PUCCH resources for the indication can be separately configured for indicating selection of each random access configuration or set of RACH resources.

In some embodiments, the resource to indicate the selected random access configuration or set of RACH resources for the random access procedure can be PUSCH resources (e.g., configured grant [CG] resources).

In some embodiments, the resource to indicate the selected random access configuration or set of RACH resources for the random access procedure can be resources for an UL wakeup signal/SRS, wherein these resources for the indication can be separately configured for indicating selection of each random access configuration or set of RACH resources.

In some embodiments, amongst the preambles and ROs of a random access configuration or set of RACH resources, preambles and/or ROs can be reserved/configured for indicating the selection of this random access configuration or set of RACH resources.

In some embodiments, amongst the preambles and ROs of a random access configuration or set of RACH resources not associated with any feature, preambles and/or ROs can be reserved/configured for indicating the selection of other random access configurations or sets of RACH resources.

At operation 420, UE 402 initiates a random access procedure. The random access procedure may be initiated/triggered by one or more of the events explained above herein.

In some embodiments, UE 402 may select the carrier (SUL or NUL) to use for the random access procedure. If the carrier to use for the random access procedure is explicitly signaled by the network 404 (e.g., by a gNB), UE 402 selects the signaled carrier for performing the random access procedure. If (i) the carrier to use for the random access procedure is not explicitly signaled by the network 404 (e.g., by a gNB), and if (ii) the cell for the random access procedure is configured with a supplementary uplink, and if (iii) the RSRP of the downlink pathloss reference is less than rsrp-ThresholdSSB-SUL, UE 402 selects the SUL carrier for performing the random access procedure. Otherwise, UE 402 selects the NUL carrier for performing the random access procedure. In some embodiments, the UL carrier selection can be skipped if the cell is configured with only one UL carrier, and UE 402 uses this UL carrier for random access.

In some embodiments, UE 402 may then select the BWP (DL/UL BWP) for the random access procedure as explained above herein.

At operation 430, UE 402 selects the random access configuration or set of RACH resources amongst the multiple random access configurations or sets of RACH resources for this random access procedure (for the selected BWP of selected UL carrier of cell/TRP toward which the random access procedure is initiated). UE 402 may select the random access configuration or set of RACH resources amongst the multiple random access configurations or sets of RACH resources based on feature(s) applicable for the random access procedure.

At operation 440, UE 402 indicates the selected random access configuration or set of RACH resources to the network 404 (e.g., a base station or node B of cell/TRP for which the random access procedure is initiated). In some embodiments, UE 402 indicates the selected random access configuration or set of RACH resources if a configuration for indicating the selected random access configuration or set of RACH resources is received from network 404. In some embodiments, UE 402 indicates the selected random access configuration or set of RACH resources if network 404 indicates (e.g., in system information or an RRC message or in a configuration of a selected random access configuration or set of RACH resources) for UE 402 to send the indication.

In some embodiments, UE 402 selects the resource corresponding to the selected random access configuration or set of RACH resources, from the resources configured for the indication (or from the resources configured for the indication for the selected BWP of the selected UL carrier).

In some embodiments, UE 402 selects an SSB/beam and then UE 402 selects the resource corresponding to the selected random access configuration or set of RACH resources and the selected SSB/beam, from the resources configured for the indication (or from the resources configured for the indication for the selected BWP of the selected UL carrier).

In some embodiments, UE 402 selects the resource, from the resources configured for the indication (or from the resources configured for the indication for the selected BWP of the selected UL carrier) and indicates (by including an identity/index in the resource selected for the random access configuration or set of RACH resources. The identity can be included in a MAC PDU or UCI or MAC CE.) the selected random access configuration or set of RACH resources to network.

In some embodiments, UE 402 selects an SSB/beam and then UE 402 selects the resource corresponding to the selected SSB/beam, from the resources configured for the indication (or from the resources configured for the indication for the selected BWP of the selected UL carrier) and indicates (by including an identity/index in the resource selected for the random access configuration or set of RACH resources. The identity can be included in a MAC PDU or UCI or MAC CE) the selected random access configuration or set of RACH resources to network.

In some embodiments, at operation 450, after transmitting the indication, UE 402 may receive an acknowledgment (ACK) for the indication indicating the selected random access configuration or set of RACH resources (the acknowledgment can be a RAR or MsgB or HARQ ack or RRC message or PDCCH) from the network 404 within a configured time interval/window. If an acknowledgment from the network for the indication indicating the selected random access configuration or set of RACH resources is not received, the UE may retransmit the indication. In some embodiments, UE 402 may apply repetition and transmit the indication multiple times to improve UL coverage (before receiving the acknowledgment).

In some embodiments, upon receiving the indication, ROs of a RACH configuration/set/RA partition indicated by UE 402 are activated. The ROs can be activated for the next T ms and network 404 monitors these ROs for receiving a random access preamble. The value of T can be up to network implementation or fixed or configurable. In some embodiments, upon receiving the indication, network 404 may activate the CFRA resources configured to UE 402.

At operation 460, after indicating the selected random access configuration or set of RACH resources to the network or after receiving an acknowledgment (the acknowledgment can be a RAR or MsgB or HARQ ack or RRC message or PDCCH) from the network 404 for the indication indicating the selected random access configuration or set of RACH resources, UE 402 performs the random access procedure using the selected random access configuration or set of RACH resources.

Although FIG. 4 illustrates one example procedure 400 for random access, various changes may be made to FIG. 4. For example, while shown as a series of operations, various operations in FIG. 4 could overlap, occur in parallel, occur in a different order, occur any number of times, be omitted, or replaced by other operations.

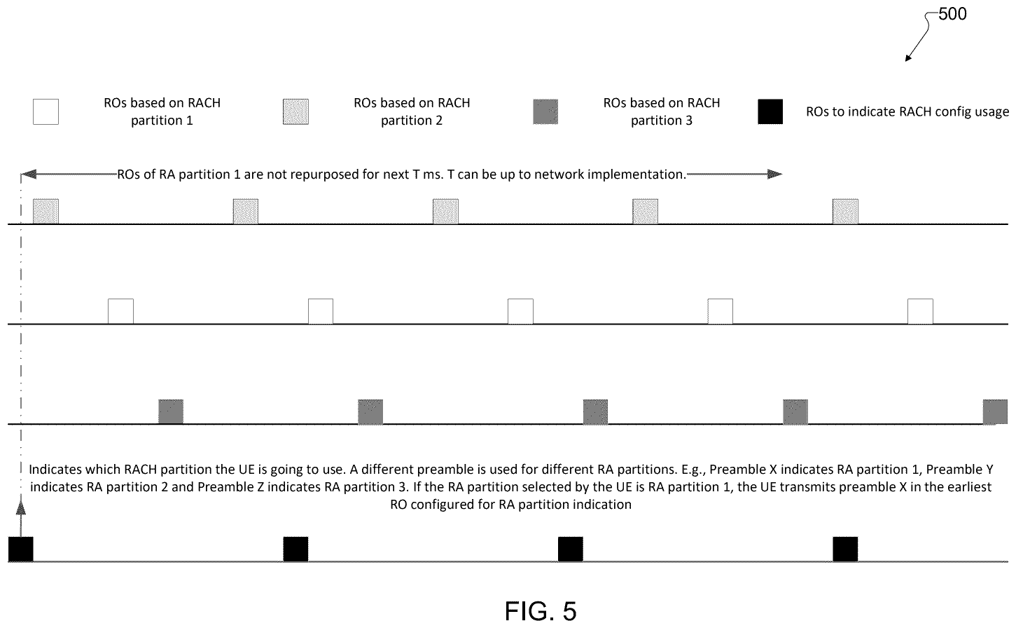

FIG. 5 illustrates an example 500 of usage of indicating a selected random access configuration or a set of RACH resources to the network according to embodiments of the present disclosure. The embodiment of the indication of FIG. 5 is for illustration only. Different embodiments of usage of indicating a selected random access configuration or set of RACH resources to the network could be used without departing from the scope of this disclosure.

In the example 500 of FIG. 5, there are three random access configurations or sets of RACH resources or RACH partitions configured by a network (e.g., network 404 of FIG. 4). The network also configures ROs to indicate RACH configuration/set/partition usage. A UE (e.g., UE 402 of FIG. 4) transmits a preamble in these ROs to indicate the selected RACH configuration/set/partition. A different preamble is used for each different RACH configuration/set/RA partition. For example, a preamble “X” may indicate RACH configuration/set/RA partition 1, a preamble “Y” may indicate RACH configuration/set/RA partition 2, and a preamble “Z” may indicate RACH configuration/set/RA partition 3. If the RACH configuration/set/RA partition selected by the UE is RACH configuration/set/RA partition 1, the UE transmits preamble X in the earliest RO configured for RACH configuration/set/RA partition indication. Upon receiving the indication by the network/base station, ROs of RACH configuration/set/RA partition 1 are not repurposed for the next T ms. Upon receiving the indication, ROs of RACH configuration/set/RA partition 1 are activated for the next T ms and the network monitors these ROs for receiving the random access preamble. T can be up to network implementation or fixed or configurable. If the indication corresponding to a RACH configuration/set/RA partition is not received by the network/base station in the time occasion (e.g., the RO reserved for this indication) to receive the indication, ROs of that RACH configuration/set/RA partition can be repurposed/reused for other purposes until the next opportunity to receive the indication.

Although FIG. 5 illustrates one example 500 of a usage of indicating a selected random access configuration or a set of RACH resources, various changes may be made to FIG. 5. For example, various changes to the number of RO partitions, the length of T, etc. could be made according to particular needs.

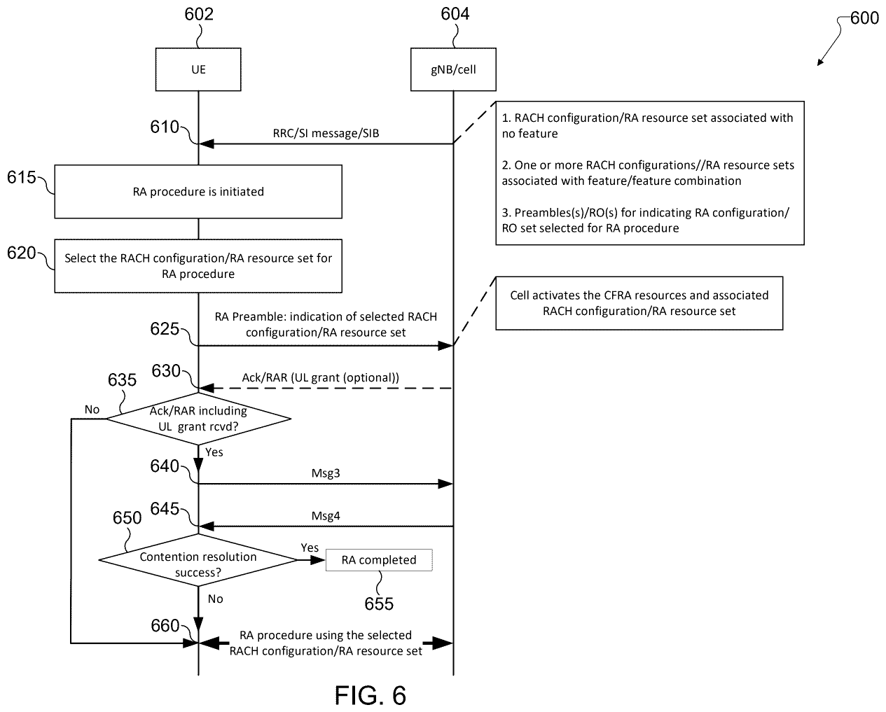

FIG. 6 illustrates another example procedure 600 for random access according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for random access could be used without departing from the scope of this disclosure.

In the example of FIG. 6, procedure 600 begins at operation 610. At operation 610, a UE 602 (which may be similar or identical to UE 116 of FIG. 1) may receive one or more random access configurations or sets of RA (or RACH) resources from network 604 (e.g., a base station or node B or DU or CU, etc.). These configuration(s) can be received for one or more cells (or TRPs), and each cell/TRP can be a serving cell/TRP or non-serving cell/TRP. These configuration(s) can be received in system information or RRC message (common or dedicated).

In some embodiments, each random access configuration or set of RA (or RACH) resources may include parameters indicating random access preambles and random access occasions. In some embodiments, each random access configuration or set of RA (or RACH) resources may include a parameter indicating association between preambles and beams/SSBs (such as preambles per beam/SSB), association between random access occasions and beams/SSBs (such as beams/SSBs per random access occasion), parameter(s) configuring random access response window and random access response search space, power ramping/control parameters etc. In some embodiments, different random access configurations or sets of RA (or RACH) resources may have their own random access parameters such as parameter(s) to indicate ROs, parameter(s) to indicate preambles, starting preamble index, parameter(s) to indicate preamble to SSB mapping, parameter(s) to indicate RO to SSB mapping, preamble group configuration, RSRP threshold for SSB selection, Msg1 subcarrier spacing, RAR window size, contention resolution timer, RSRP threshold for SSB selection, RSRP threshold for SUL selection, RA prioritisation parameters, power ramping parameters, maximum preamble transmission, etc. In some embodiments, the random access configuration or set of RA (or RACH) resources may share some random access parameters with other random access configurations or sets of RA (or RACH) resources and some random access parameters are not shared. In some embodiments, the random access configuration or set of RA (or RACH) resources may share some random access parameters with other random access configurations or sets of RA (or RACH) resources such as parameter(s) to indicate RO, parameter(s) to indicate RO to SSB mapping, Msg1 subcarrier spacing, RAR window size, contention resolution timer, RSRP threshold for SUL selection, RA prioritisation parameters, power ramping parameters, maximum preamble transmission, RA prioritisation parameters and have its own random access parameters such as parameter(s) to indicate preambles, starting preamble index, parameter(s) to indicate preamble to SSB mapping, preamble group configuration, RSRP threshold for SSB selection, etc.

In some embodiments, one or more random access configurations or sets of RA (or RACH) resources from network 604 can be received separately for each uplink carrier (SUL, NUL).

In some embodiments, one or more random access configurations or sets of RA (or RACH) resources from network 604 can be per BWP (or per BWP per uplink carrier[SUL, NUL]). Note that the uplink carrier can be configured with one or more BWPs.

In some embodiments, the random access configuration or set of RA (or RACH) resources is associated with one or more features (e.g., SDT, RedCap, eRedCap, Msg1 repetitions, Msg3 repetitions, slicing, coverage enhancements, etc.). In some embodiments, a random access configuration or set of RA (or RACH) resources may be associated with no feature.

In some embodiments, UE 602 may receive a configuration indicating resources (time, frequency, sequence) to indicate the selected random access configuration or set of RACH resources for the random access procedure. This configuration can be received in system information or an RRC message (common or dedicated). This configuration can be received for one or more cells. This configuration can be per BWP (or per BWP per UL carrier for a cell configured with BWP[s] and UL carrier[s]) for a cell configured with BWP(s). This configuration can be received for each random access configuration or set of RACH resources associated with one or more features. This configuration can be received for one or more random access configurations or sets of RACH resources associated with one or more features. If the configuration indicating the resources (time, frequency, sequence) to indicate the selected random access configuration or set of RACH resources for a random access procedure is received for a random access configuration or set of RACH resources for the random access procedure, the UE indicates the selection of that random access configuration or set of RACH resources for the random access procedure using the received configuration.

In some embodiments, resource(s) to indicate the selected random access configuration or set of RACH resources for a random access procedure can be a random access preamble and/or random access occasion and/or PUSCH occasion, wherein the random access preamble and/or random access occasion and/or PUSCH occasion for the indication can be separately configured for indicating selection of each random access configuration or set of RACH resources. For example, assume there are two random access configurations or sets of RACH resources. In some embodiments, one preamble (e.g., “Preamble A”) can be reserved/configured to indicate selection of a random access configuration/set of RACH resources “1” and another preamble (e.g., “Preamble B”) can be reserved configured to indicate selection of a random access configuration/set of RACH resources “2”. In some embodiments, multiple preambles can be reserved/configured to indicate selection of random access configuration/set of RACH resources 1, wherein the preamble is associated with an SSB. In some embodiments, multiple preambles can be reserved/configured to indicate selection of random access configuration/set of RACH resources 2, wherein each preamble is associated with an SSB. ROs for indicating selection of the random access configuration/set of RACH resources can be configured by network 604. In these embodiments, UE 602 transmits the preamble for indicating selection of the random access configuration/set of RACH resources in one of these ROs. In case multiple preambles are reserved/configured to indicate selection of the random access configuration/set of RACH resources, UE 602 selects an SSB and then selects the preamble from multiple preambles corresponding to the elected SSB. In some embodiments, one preamble (e.g., Preamble A) can be reserved/configured to indicate selection of random access configuration/set of RACH resources 1 and random access configuration/set of RACH resources 2. ROs for indicating selection of the random access configuration/set of RACH resources can be configured by network 604. Separate ROs amongst these ROs can be indicated for random access configuration/set of RACH resources 1 and random access configuration/set of RACH resources 2. UE 602 transmits the preamble A for indicating selection of random access configuration/set of RACH resources 1 in a RO for random access configuration/set of RACH resources 1. UE 602 transmit the preamble A for indicating selection of random access configuration/set of RACH resources 2 in RO for random access configuration/set of RACH resources 2. In some embodiments, multiple ROs can be reserved to indicate selection of random access configuration/set of RACH resources 1, wherein each RO is associated with one or more SSBs. In some embodiments, multiple ROs can be reserved to indicate selection of random access configuration/set of RACH resources 2, wherein each RO is associated with one or more SSBs. In case multiple ROs are reserved/configured to indicate selection of a random access configuration/set of RACH resources, UE 602 selects an SSB and then selects an RO from multiple ROs corresponding to selected SSB. In some embodiments, one preamble (e.g., Preamble A) can be reserved/configured to indicate selection of random access configuration/set of RACH resources 1 and another preamble (e.g., Preamble B) can be reserved/configured to indicate selection of random access configuration/set of RACH resources 2. ROs for indicating selection of the random access configuration/set of RACH resources can be configured by network 604. Separate ROs amongst these ROs can be indicated for random access configuration/set of RACH resources 1 and random access configuration/set of RACH resources 2. UE 602 transmits the preamble A for indicating selection of random access configuration/set of RACH resources 1 in an RO for random access configuration/set of RACH resources 1. UE 602 transmits the preamble B for indicating selection of random access configuration/set of RACH resources 2 in an RO for random access configuration/set of RACH resources 2. In some embodiments one preamble (e.g., Preamble A) can be reserved/configured to indicate selection of the random access configuration/set of RACH resources 1 and random access configuration/set of RACH resources 2. A PUSCH occasion for a MsgA MAC PDU are also configured. UE 602 transmits preamble A and transmits the MsgA MAC PDU in the PUSCH occasion, wherein the MsgA MAC PDU indicates whether UE 602 has selected random access configuration/set of RACH resources 1 or random access configuration/set of RACH resources 2.

In some embodiments, if a resource to indicate the selected random access configuration or set of RACH resources for the random access procedure is not received, UE 402 may not indicate the selection of that random access configuration or set of RACH resources for the random access procedure. Alternately, in some embodiments, if a resource to indicate the selected random access configuration or set of RACH resources for the random access procedure is not received, UE 402 may use the default configuration (pre-defined/preconfigured) to indicate the selection of that random access configuration or set of RACH resources for the random access procedure.

In some embodiments, the resource to indicate the selected random access configuration or set of RACH resources for the random access procedure can be PUCCH resources, wherein the PUCCH resources for the indication can be separately configured for indicating selection of each random access configuration or set of RACH resources.

In some embodiments, the resource to indicate the selected random access configuration or set of RACH resources for the random access procedure can be PUSCH resources (e.g., CG resources).

In some embodiments, the resource to indicate the selected random access configuration or set of RACH resources for the random access procedure can be resources for an UL wakeup signal/SRS, wherein these resources for the indication can be separately configured for indicating selection of each random access configuration or set of RACH resources.

In some embodiments, amongst the preambles and ROs of a random access configuration or set of RACH resources, preambles and/or ROs can be reserved/configured for indicating the selection of this random access configuration or set of RACH resources.

In some embodiments, amongst the preambles and ROs of a random access configuration or set of RACH resources not associated with any feature, preambles and/or ROs can be reserved/configured for indicating the selection of other random access configurations or sets of RACH resources.

At operation 615, UE 602 initiates a random access procedure. The random access procedure may be initiated/triggered by one or more of the events explained above herein.

In some embodiments, UE 602 may select the carrier (SUL or NUL) to use for the random access procedure. If the carrier to use for the random access procedure is explicitly signaled by the network 604 (e.g., by a gNB), UE 602 selects the signaled carrier for performing the random access procedure. If (i) the carrier to use for the random access procedure is not explicitly signaled by the network 604 (e.g., by a gNB), and if (ii) the cell for the random access procedure is configured with supplementary uplink, and if (iii) the RSRP of the downlink pathloss reference is less than rsrp-ThresholdSSB-SUL, UE 602 selects the SUL carrier for performing random access procedure. Otherwise, UE 602 selects the NUL carrier for performing the random access procedure. In some embodiments, the UL carrier selection can be skipped if the cell is configured with only one UL carrier, and UE 602 uses this UL carrier for random access.

In some embodiments, UE 602 may then select the BWP (DL/UL BWP) for the random access procedure as explained above herein.

At operation 620, UE 602 selects the random access configuration or set of RACH resources amongst the multiple random access configurations or sets of RACH resources for this random access procedure (for the selected BWP of selected UL carrier of cell/TRP toward which the random access procedure is initiated). UE 602 may select the random access configuration or set of RACH resources amongst the multiple random access configurations or sets of RACH resources based on feature(s) applicable for the random access procedure.

At operation 625, UE 602 indicates the selected random access configuration or set of RACH resources to the network 604 (e.g., a base station or node B of cell/TRP for which the random access procedure is initiated). In some embodiments, UE 602 indicates the selected random access configuration or set of RACH resources if a configuration for indicating the selected random access configuration or set of RACH resources is received from network 604. In some embodiments, UE 602 indicates the selected random access configuration or set of RACH resources if network 604 indicates (e.g., in system information or an RRC message or in a configuration of a selected random access configuration or set of RACH resources) for UE 602 to send the indication.

In some embodiments, UE 602 selects the resource corresponding to the selected random access configuration or set of RACH resources, from the resources configured for the indication (or from the resources configured for the indication for the selected BWP of the selected UL carrier).

In some embodiments, UE 602 selects an SSB/beam and then UE 602 selects the resource corresponding to the selected random access configuration or set of RACH resources and the selected SSB/beam, from the resources configured for the indication (or from the resources configured for the indication for the selected BWP of the selected UL carrier).

In some embodiments, UE 602 selects the resource, from the resources configured for the indication (or from the resources configured for the indication for the selected BWP of the selected UL carrier) and indicates (by including an identity/index in the resource selected for the random access configuration or set of RACH resources. The identity can be included in a MAC PDU or UCI or MAC CE.) the selected random access configuration or set of RACH resources to network.

In some embodiments, UE 602 selects an SSB/beam and then UE 602 selects the resource corresponding to the selected SSB/beam, from the resources configured for the indication (or from the resources configured for the indication for the selected BWP of the selected UL carrier) and indicates (by including an identity/index in the resource selected for the random access configuration or set of RACH resources. The identity can be included in a MAC PDU or UCI or MAC CE) the selected random access configuration or set of RACH resources to network.

In some embodiments, at operation 630, after transmitting the indication, UE 602 may receive an acknowledgment for the indication indicating the selected random access configuration or set of RACH resources (the acknowledgment can be a RAR or MsgB or HARQ ack or RRC message or PDCCH) from the network 604 within a configured time interval/window. If an acknowledgment from the network for the indication indicating the selected random access configuration or set of RACH resources is not received, the UE may retransmit the indication. In some embodiments, UE 602 may apply repetition and transmit the indication multiple times to improve UL coverage (before receiving the acknowledgment).

In some embodiments, upon receiving the indication, ROs of a RACH configuration/set/RA partition indicated by UE 602 are activated. The ROs can be activated for the next T ms and network 604 monitors these ROS for receiving a random access preamble. The value of T can be up to network implementation or fixed or configurable. In some embodiments, upon receiving the indication, network 604 may activate the CFRA resources configured to UE 602.

At operation 635, after transmitting the indication, UE 602 determines whether (e.g., at operation 630) an acknowledgment for the indication indicating the selected random access configuration or set of RACH resources (the acknowledgment can be a RAR or MsgB or HARQ ack or RRC message or PDCCH) including an UL grant has been received. If an acknowledgment including a UL grant is received (e.g., UE 602 receives a RAR or MsgB including a UL grant), procedure 600 proceeds to operation 640. Otherwise, if an acknowledgment is received but the acknowledgement does not include an UL grant (e.g., UE 602 receives a RAR or MsgB without a UL grant), procedure 600 proceeds to operation 660.

In some embodiments, at operation 640, UE 602 may transmit a Msg3 in the received UL grant and start the contention resolution timer.

In some embodiments, at operation 645, UE 602 may receive a Msg4 while the contention resolution timer is running.

At operation 650, UE 602 determines whether contention resolution is successful. While the contention resolution timer is running, if a Msg4 is received (e.g., at operation 645) the contention resolution is successful and procedure 600 proceeds to operation 655. Otherwise, if the contention resolution timer expires, procedure 600 proceeds to operation 660.

At operation 655, UE 602 determines that the random access procedure is completed.

At operation 660, UE 602 UE performs the random access procedure using the selected random access configuration or set of RACH resources.

Although FIG. 6 illustrates one example procedure 600 for random access, various changes may be made to FIG. 6. For example, while shown as a series of operations, various operations in FIG. 6 could overlap, occur in parallel, occur in a different order, occur any number of times, be omitted, or replaced by other operations.

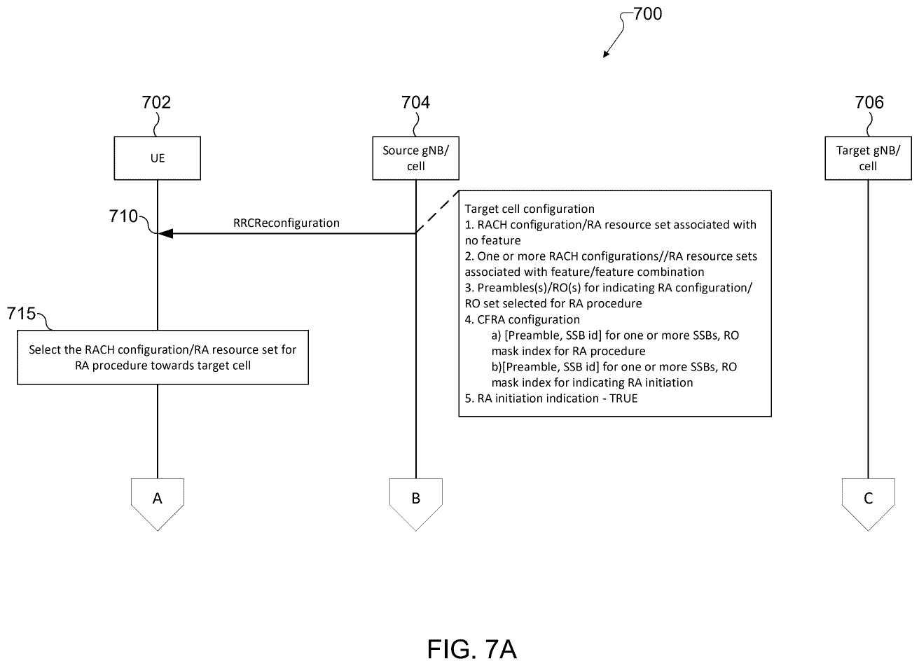

FIGS. 7A-7B illustrate another example procedure 700 for random access according to embodiments of the present disclosure. An embodiment of the procedure illustrated in FIGS. 7A-7B is for illustration only. One or more of the components illustrated in FIGS. 7A-7B may be implemented in specialized circuitry configured to perform the noted functions or one or more of the components may be implemented by one or more processors executing instructions to perform the noted functions. Other embodiments of a procedure for random access could be used without departing from the scope of this disclosure.

In the example of FIGS. 7A-7B, procedure 700 begins at operation 710. At operation 710, a UE 702 (which may be similar or identical to UE 116 of FIG. 1) receives an RRCReconfiguration message from a source gNB/Cell 704. The RRCReconfiguration message includes a target cell configuration. The target cell configuration may include one or more of 1) a RACH configuration/RA resource set associated with no feature, 2) one or more RACH configurations/RA resource sets associated with a feature/feature combination/features, 3) preambles(s)/RO(s) for indicating an RA configuration/RO set selected for an RA procedure, 4) a CFRA configuration that includes: a) a [Preamble, SSB id] for one or more SSBs, RO mask index for RA procedure, and b) a [Preamble, SSB id] for one or more SSBs, RO mask index for indicating RA initiation, and 5) an RA initiation indication set to TRUE.

At operation 715, UE 702 selects a RACH configuration/RA resource set for an RA procedure towards target cell 706.

In some embodiments, at operation 720, if dedicated RA resources (i.e., a [Preamble, SSB id] for one or more SSBs, RO mask index) for indicating RA initiation is received, UE 702 sends an RA initiation indication. In these embodiments, UE 702 transmits an RA initiation indication to target cell 706 using the dedicated RA resources (i.e., a [Preamble, SSB id] for one or more SSBs, RO mask index) for indicating the RA initiation. Target cell 706 then activates the CFRA resources (e.g., [Preamble, SSB id] for one or more SSBs, RO mask index) for the RA procedure and associated RACH configuration/RA resource set upon receiving the indication.

Alternately, in some embodiments, at operation 725, if an RA initiation indication set to TRUE is received by UE 702 and if dedicated RA resources (i.e., 4(b)) for indicating RA initiation is received, UE 702 sends an RA initiation indication using dedicated RA resources (i.e., a [Preamble, SSB id] for one or more SSBs, RO mask index). In these embodiments, UE 702 transmits the RA initiation indication to target cell 706 using dedicated RA resources (i.e., a [Preamble, SSB id] for one or more SSBs, RO mask index) for indicating the RA initiation. Target cell 706 then activates the CFRA resources (e.g. [Preamble, SSB id] for one or more SSBs, RO mask index) for RA procedure and associated RACH configuration/RA resource set upon receiving the indication.

Alternately, in some embodiments, at operation 730, if an RA initiation indication set to TRUE is received by UE 702 and if dedicated RA resources (i.e., a [Preamble, SSB id] for one or more SSBs, RO mask index) for indicating RA initiation is not received, UE 702 sends an RA initiation indication using common RA resources (i.e., preambles(s)/RO(s) for indicating an RA configuration/RO set selected for an RA procedure). In these embodiments, UE 702 transmits to target cell 706 an RA initiation indication using the common RA resources (i.e., preambles(s)/RO(s) for indicating an RA configuration/RO set selected for an RA procedure) for indicating RA initiation. Target cell 706 then activates the CFRA resources (e.g., [Preamble, SSB id] for one or more SSBs, RO mask index) for the RA procedure and associated RACH configuration/RA resource set upon receiving the indication.

At operation 735, after transmitting the RA initiation indication to the target cell 706 or after receiving an acknowledgment (the acknowledgment can be a RAR or MsgB or HARQ ack or RRC message or PDCCH) from the target cell 706 for the indication, UE 702 performs the random access procedure using the selected random access configuration or set of RACH resources.

Procedure 700 can also be applied for PDCCH ordered CFRA, where a CFRA configuration can be indicated by a PDCCH order received from a serving cell “X” (i.e., the source cell 704 in FIGS. 7A-7B is replaced by the serving cell X) for a serving cell “Y” (i.e., the target cell 706 in FIGS. 7A-7B is replaced by serving cell Y). Serving cell Y can be the same as the serving cell X or different from the serving cell X.

Although FIGS. 7A-7B illustrate one example procedure 700 for random access, various changes may be made to FIGS. 7A-7B. For example, while shown as a series of operations, various operations in FIGS. 7A-7B could overlap, occur in parallel, occur in a different order, occur any number of times, be omitted, or replaced by other operations.

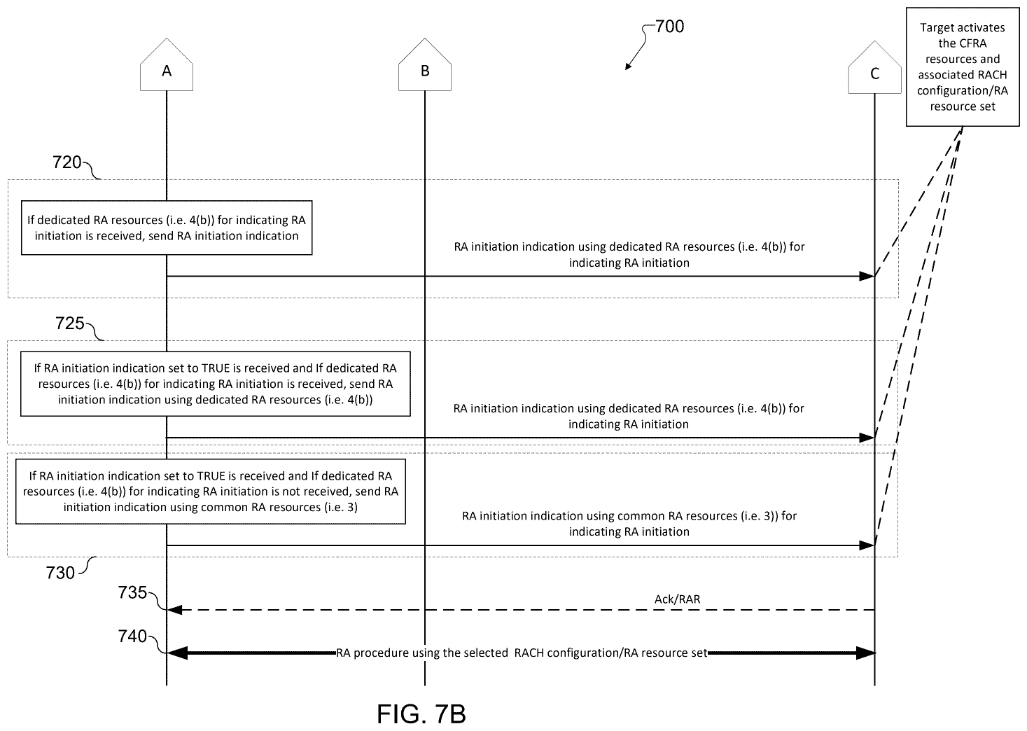

FIG. 8 illustrates an example procedure 800 for 2 step random access according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for random access could be used without departing from the scope of this disclosure.

In the example of FIG. 8, procedure 800 begins at operation 810. At operation 810, a UE 802 (which may be similar or identical to UE 116 of FIG. 1) selects an SSB/CSI-RS amongst the transmitted SSBs/CSI-RSs in a cell. UE 802 may select an SSB/CSI-RS with a best SS-RSRP/CSI-RSRP or UE 802 may select an SSB/CSI-RS with an SS-RSRP/CSI-RSRP above a configured SS-RSRP threshold/CSI-RSRP threshold or UE 802 may select any SSB/CSI-RS (if no SSB/CSI-RS above the SS-RSRP threshold/CSI-RSRP threshold is available).

In some embodiments, UE 802 may select between an RA preamble group A or RA preamble group B as discussed in greater detail below. In these embodiments, UE 802 selects a preamble amongst the preambles associated with the selected SSB/CSI-RS and the selected RA preamble group, and UE 802 selects a RACH occasion (RO) amongst the ROs associated with the selected SSB/CSI-RS.

Alternately, in some embodiments, UE 802 may select an RO group as discussed in greater detail below. In these embodiments, UE 802 selects a preamble amongst the preambles associated with the selected SSB/CSI-RS, and UE 802 selects a RACH occasion (RO) amongst the ROs associated with the selected SSB/CSI-RS and the selected RO group.

UE 802 selects a PUSCH occasion corresponding to the selected preamble and RO. UE 802 then transmits the selected preamble in the selected RACH occasion to network 804 (e.g., a base station of the cell).

At operation 815, UE 802 generates a MsgA MAC PDU. UE stores the MsgA MAC PDU in MsgA buffer (for retransmission later).

In some embodiments, UE 802 may include channel quality information in the MsgA MAC PDU. Whether to include channel quality information in the MsgA MAC PDU may be indicated by network 804 (e.g., in SI or an RRC message or a PDCCH or a MAC CE). In some embodiments, UE 802 includes the cell quality of the cell to which UE 802 is transmitting the MsgA. Alternately, in some embodiments, UE 802 includes the SS-RSRP (RSRQ)/CSI-RSRP (RSRQ) of the selected SSB/CSI-RS in the MsgA MAC PDU. The SSB identity/CSI-RS identity of SSB/CSI-RS whose RSRP/RSRQ is reported may be included in the MsgA MAC PDU. Alternately, in some embodiments, UE 802 includes the SS-RSRP (RSRQ)/CSI-RSRP (RSRQ) of the SSB/CSI-RS with the highest SS-RSRP (RSRQ)/CSI-RSRP (RSRQ) in the MsgA MAC PDU. Alternately, in some embodiments, UE 802 includes the CQI in the MsgA MAC PDU. Alternately, in some embodiments, UE 802 includes the SS-RSRP (RSRQ)/CSI-RSRP (RSRQ) of multiple SSBs/CSI-RSs in the MsgA MAC PDU.

In some embodiments, UE 802 may include an RRC message (e.g., an RRCResume request, RRC connection request, RRCReconfiguration complete, etc.) in the MsgA MAC PDU. In some embodiments, UE 802 may include a C-RNTI in the MsgA MAC PDU. In some embodiments, UE 802 may include a buffer status report in the MsgA MAC PDU.

UE 802 transmits the MsgA MAC PDU in the selected PUSCH occasion.

At operation 820, upon receiving the preamble and MsgA MAC PDU from UE 802, network 804 (e.g., a base station of the cell) generates a MsgB MAC PDU. The MsgB MAC PDU includes a success RAR (contention resolution identity, C-RNTI, RAPID). Network 804 may determine the size of the MsgB and MCS for transmitting the DL TB including the MsgB based on received channel quality info in the MsgA MAC PDU. Network 804 may determine whether to include data of a dedicated logical channel/signaling radio bearer/data radio bearer (e.g., an RRC message in response to the RRC message received in MsgA or data from the SRB or DRB) in the MsgB based on the received channel quality info in the MsgA MAC PDU. If the channel quality is poor, network 804 may choose a lower modulation order, higher coding rate and smaller size of MsgB. If the channel quality is adequate, network 804 may choose a higher modulation order, lower coding rate and larger size of MsgB. In some embodiments, the MsgB may include an UL grant in the success RAR, and this UL grant can be used for UL transmission after successful completion of the random access procedure (i.e., after contention resolution is successful).

Network 804 transmits the MsgB MAC PDU to UE 802.

At operation 824, after UE 802 receives the MsgB MAC PDU, UE 802 performs contention resolution based on a contention resolution identity.

At operation 830, if the contention resolution is successful, UE 802 transmits HARQ feedback (ACK) for the received MsgB. UE 802 processes the data of a dedicated logical channel (e.g., an RRC message in response to the RRC message received in MsgA or data from a SRB or DRB) in MsgB, if any, and UE 802 starts monitoring a PDCCH addressed to a C-RNTI.

At operation 835, upon receiving the HARQ feedback (ACK) for the MsgB, network 804 may schedule a DL transmission and/or UL grant (for UL transmission by UE 802) to UE 802. Network 804 may determine a MCS and size for the DL TB or UL grant based on the received channel quality information in the MsgA MAC PDU until new channel quality information from UE 802 is received.

As noted above, in some embodiments, UE 802 may select between an RA preamble group A or RA preamble group B at operation 810. The selection between the RA preamble group A and RA preamble group B may be performed as follows:

If contention-free random access resources for 2-step RA type have not been configured and if a random access preambles group has not yet been selected during the current random access procedure (or if contention-free random access resources for 2-step RA type have not been configured):
if random access preambles group B for 2-step RA type is configured, if the potential MsgA payload size (UL data available for transmission plus MAC subheader and, where required, MAC CEs) is greater than the ra-MsgA-SizeGroupA and the pathloss is less than PCMAX (of the Serving Cell performing the random access procedure)−msgA-PreambleReceivedTargetPower−msgA-DeltaPreamble−messagePowerOffsetGroupB; ((OR if the potential MSGA payload size (UL data available for transmission plus MAC subheader and, where required, MAC CEs) is greater than the ra-MsgA-SizeGroupA and DL signal strength (Cell quality or SS-RSRP/CSI-RSRP of selected SSB/CSI-RS>threshold)), or if the random access procedure was initiated for the CCCH logical channel and the CCCH SDU size plus MAC subheader is greater than ra-MsgA-SizeGroupA, UE 802 selects the random access preambles group B.
Otherwise, UE 802 selects the random access preambles group A.

Otherwise, if contention-free random access resources for 2-step RA type have been configured and if random access preambles group has not yet been selected during the current random access procedure (else if contention-free random access resources for 2-step RA type have been configured):
if random access preambles group B for 2-step RA type is configured; and if the transport block size of the MSGA payload configured in the rach-ConfigDedicated corresponds to the transport block size of the MSGA payload associated with random access preambles group B, UE 802 selects the random access preambles group B.
Otherwise, UE 802 selects the random access preambles group A.

Otherwise, (i.e., a random access preambles group has been selected during the current random access procedure), UE 802 selects the same group of random access preambles as was used for the random access preamble transmission attempt corresponding to the earlier transmission of the MsgA.

ra-MsgA-SizeGroupA, msgA-PreambleReceivedTargetPower, msgA-DeltaPreamble, messagePowerOffsetGroupB, and the threshold can be signaled by network 804 (e.g., in SI or an RRC message).

As noted above, in some embodiments, UE 802 may select an RO group and an RO at operation 810. In some embodiments, the selection of the RO group may be between an RO group A and an RO group B. Alternately, in some embodiments, the selection of the RO group may be between an RO group A, an RO group B, and an RO group C.

The selection between RO group A and RO group B at operation 810 may be performed as follows:

If contention-free random access resources for 2-step RA type have not been configured and if an RO group has not yet been selected during the current random access procedure (or if contention-free random access resources for 2-step RA type have not been configured:
if RO group B for 2-step RA type is configured:
   if the potential MsgA payload size (UL data available for transmission plus MAC subheader and, where required, MAC CEs) is greater than the ra-MsgA-SizeGroupA and the pathloss is less than PCMAX (of the Serving Cell performing the random access procedure)−msgA-PreambleReceivedTargetPower-msgA−DeltaPreamble−messagePowerOffsetGroupB; (OR if the potential MSGA payload size (UL data available for transmission plus MAC subheader and, where required, MAC CEs) is greater than the ra-MsgA-SizeGroupA and DL signal strength (Cell quality or SS-RSRP/CSI-RSRP of selected SSB/CSI-RS>threshold)); or if the random access procedure was initiated for the CCCH logical channel and the CCCH SDU size plus MAC subheader is greater than ra-MsgA-SizeGroupA, UE 802 selects the RO group B.
   Otherwise, UE 802 selects the RO group A.

Otherwise, if contention-free random access resources for 2-step RA type have been configured and if an RO group has not yet been selected during the current random access procedure (or if contention-free random access resources for 2-step RA type have been configured):
If RO group B for 2-step RA type is configured, and if the transport block size of the MsgA payload configured in the rach-ConfigDedicated corresponds to the transport block size of the MsgA payload associated with RO group B, UE 802 selects the RO group B.
Otherwise, UE 802 selects the RO group A.

Otherwise (i.e., an RO group has been selected during the current random access procedure), UE 702 selects the same group of ROs as was used for the random access preamble transmission attempt corresponding to the earlier transmission of MSGA.

The selection between RO group A/RO group B/RO group C at operation 810 may be performed as follows:
if contention-free random access resources for 2-step RA type have not been configured and if an RO group has not yet been selected during the current random access procedure (or if contention-free random access resources for 2-step RA type have not been configured):
if RO group B/C for 2-step RA type is configured:
   if the potential MsgA payload size (UL data available for transmission plus MAC subheader and, where required, MAC CEs) is greater than the ra-MsgA-SizeGroupA and the pathloss is less than PCMAX (of the Serving Cell performing the random access procedure)−msgA-PreambleReceivedTargetPower−msgA-DeltaPreamble−messagePowerOffsetGroupB; (OR if the potential MSGA payload size (UL data available for transmission plus MAC subheader and, where required, MAC CEs) is greater than the ra-MsgA-SizeGroupA and DL signal strength (Cell quality or SS-RSRP/CSI-RSRP of selected SSB/CSI-RS>threshold)), UE 802 selects the RO group B. Otherwise, if the random access procedure was initiated for the CCCH logical channel and the CCCH SDU size plus MAC subheader is greater than ra-MsgA-SizeGroupA, UE 802 selects the RO group C
   Otherwise, UE 802 selects the RO group A.

Otherwise, if contention-free random access resources for 2-step RA type have been configured and if an RO group has not yet been selected during the current random access procedure (or if contention-free random access resources for 2-step RA type have been configured):
if RO group B for 2-step RA type is configured, and if the transport block size of the MsgA payload configured in the rach-ConfigDedicated corresponds to the transport block size of the MSGA payload associated with RO group B, UE 802 selects the RO group B.
Otherwise, if RO group C for 2-step RA type is configured, and if the transport block size of the MsgA payload configured in the rach-ConfigDedicated corresponds to the transport block size of the MsgA payload associated with RO group C, UE 802 selects the RO group B.
Otherwise, UE 802 selects the RO group A.

Otherwise (i.e., RO group has been selected during the current random access procedure), UE 802 selects the same group of ROs as was used for the random access preamble transmission attempt corresponding to the earlier transmission of the MsgA.

Although FIG. 8 illustrates one example procedure 800 for 2 step random access, various changes may be made to FIG. 8. For example, while shown as a series of operations, various operations in FIG. 8 could overlap, occur in parallel, occur in a different order, occur any number of times, be omitted, or replaced by other operations.

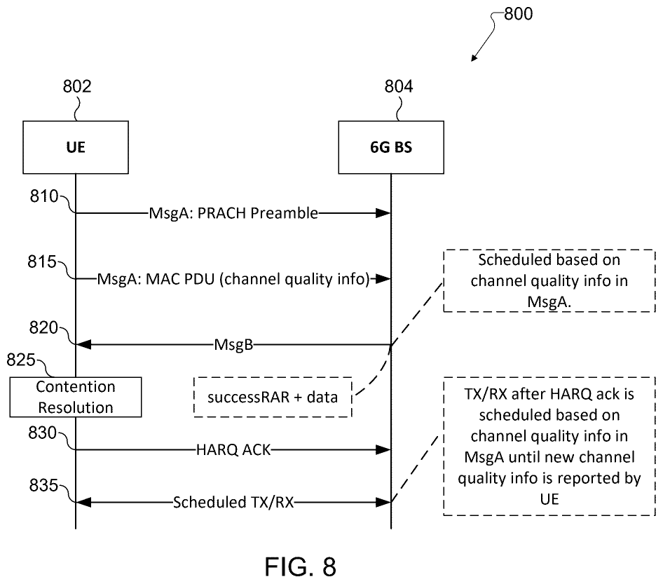

FIG. 9 illustrates an example procedure 900 for 4 step random access according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for 4 step random access could be used without departing from the scope of this disclosure.

In the example of FIG. 9, procedure 900 begins at operation 910. At operation 910, a UE 902 (which may be similar or identical to UE 116 of FIG. 1) selects an SSB/CSI-RS amongst the transmitted SSBs/CSI-RSs in a cell. UE 902 may select an SSB/CSI-RS with a best SS-RSRP/CSI-RSRP or UE 802 may select an SSB/CSI-RS with an SS-RSRP/CSI-RSRP above a configured SS-RSRP threshold/CSI-RSRP threshold or UE 902 may select any SSB/CSI-RS (if no SSB/CSI-RS above the SS-RSRP threshold/CSI-RSRP threshold is available).

Inn some embodiments, UE 902 may select an RO group as discussed in greater detail below. In these embodiments, UE 902 selects a preamble amongst the preambles associated with the selected SSB/CSI-RS, and UE 902 selects a RACH occasion (RO) amongst the ROs associated with the selected SSB/CSI-RS and the selected RO group.

UE 902 transmits the selected preamble in the selected RACH occasion to network 904 (e.g., a base station of the cell) and monitors for a RAR in a RAR window. If the RAR window expires and UE 802 did not receive a RAR successfully, UE 902 transmits the PRACH preamble to network 904 again.

At operation 915, upon receiving the preamble, network 904 (e.g., a base station of the cell) generates a RAR MAC PDU. The RAR MAC PDU includes a RAR (TC-RNTI, RAPID, UL grant). Network 904 then transmits the RAR MAC PDU.

At operation 920, upon receiving the RAR MAC PDU, UE 902 generates a Msg3 MAC PDU and stores the Msg3 MAC PDU in UE 902's Msg3 buffer (the Msg3 buffer is empty when the random access procedure is initiated). UE 902 transmits the Msg3 in the UL grant received in the RAR MAC PDU and starts contention resolution timer. UE 902 then starts monitoring a PDCCH addressed to the TC-RNTI.

At operation 925, UE 902 receives a DL TB including a Msg4.

At operation 930, UE 902 performs contention resolution based on a contention resolution identity in Msg4. If contention resolution is successful, the random access procedure is completed, and contention resolution timer is stopped. If the contention resolution timer expires, UE 902 transmits the PRACH preamble to network 904 again.

As noted above, in some embodiments, UE 902 may select an RO group at operation 910. In some embodiments, the selection of the RO group may be between an RO group A and an RO group B. Alternately, in some embodiments, the selection of the RO group may be between an RO group A, an RO group B, and an RO group C.

The selection between RO group A and RO group B at operation 910 may be performed as follows:
If the RA TYPE is switched from 2-stepRA to 4-stepRA (note that during a random access procedure UE 902 may first perform 2 step RA and switch to 4 step RA after transmitting MsgA a configurable number of times):
if a RO group was selected during the current random access procedure, UE 902 selects the same group of ROs as was selected for the 2-step RA type.
Otherwise, if RO group B is configured, and if the transport block size of the MsgA payload configured in the rach-ConfigDedicated corresponds to the transport block size of the MsgA payload associated with RO group B, UE 902 selects the RO group B.
Otherwise, UE 902 selects the RO group A.

Otherwise, if UE 902's Msg3 buffer is empty:
if RO group B is configured: if the potential Msg3 size (UL data available for transmission plus MAC subheader(s) and, where required, MAC CEs) is greater than ra-Msg3 SizeGroupA and the pathloss is less than PCMAX (of the Serving Cell performing the random access procedure)−preambleReceivedTargetPower−msg3-DeltaPreamble−messagePowerOffsetGroupB or if the random access procedure was initiated for the CCCH logical channel and the CCCH SDU size plus MAC subheader is greater than ra-Msg3 SizeGroupA, UE 902 selects the RO group B.
Otherwise, UE 902 selects the RO group A.

Otherwise (i.e., Msg3 is being retransmitted), UE 902 selects the same group of ROs as was used for the random access preamble transmission attempt corresponding to the first transmission of Msg3.

The selection between RO group A/RO group B/RO group C at operation 910 may be performed as follows:

If the RA TYPE is switched from 2-stepRA to 4-stepRA (note that during random access procedure UE 902 may first perform 2 step RA and switch to 4 step RA after transmitting MsgA configurable number of times):
If a RO group was selected during the current random access procedure, UE 902 selects the same group of ROs as was selected for the 2-step RA type.
Otherwise, if RO group B is configured, and if the transport block size of the MSGA payload configured in the rach-ConfigDedicated corresponds to the transport block size of the MSGA payload associated with RO group B, UE 902 selects the RO group B.
Otherwise, if RO group C is configured, and if the transport block size of the MSGA payload configured in the rach-ConfigDedicated corresponds to the transport block size of the MSGA payload associated with RO group C, UE 902 selects the RO group C.
Otherwise, UE 902 selects the RO group A.

Otherwise, if UE 902's Msg3 buffer is empty:
If RO group B is configured, and if the potential Msg3 size (UL data available for transmission plus MAC subheader(s) and, where required, MAC CEs) is greater than ra-Msg3SizeGroupA and the pathloss is less than PCMAX (of the Serving Cell performing the random access procedure)−preambleReceivedTargetPower−msg3-DeltaPreamble−messagePowerOffsetGroupB, UE 902 selects the RO group B.
Otherwise, if RO group C is configured, and if the random access procedure was initiated for the CCCH logical channel and the CCCH SDU size plus MAC subheader is greater than ra-Msg3SizeGroupA, UE 902 selects the RO group C.
Otherwise, if RO group B is configured, and if the random access procedure was initiated for the CCCH logical channel and the CCCH SDU size plus MAC subheader is greater than ra-Msg3SizeGroupA, UE 902 selects the RO group B.
Otherwise, UE 902 selects the RO group A.

Otherwise (i.e., Msg3 is being retransmitted), UE 902 selects the same group of ROs as was used for the random access preamble transmission attempt corresponding to the first transmission of Msg3.

Although FIG. 9 illustrates one example procedure 900 for 4 step random access, various changes may be made to FIG. 9. For example, while shown as a series of operations, various operations in FIG. 9 could overlap, occur in parallel, occur in a different order, occur any number of times, be omitted, or replaced by other operations.

In some embodiments for signaling RO groups A and B, an RO mask index can be signaled.

In some embodiments, the RO mask index for group A and the RO mask index for group B can be signaled in the RA configuration. In these embodiments the RO mask index for group A indicates which ROs of SSB are for group A, and the RO mask index for group B indicates which ROs of SSB are for group B.

In some embodiments, an RO mask index for group A and an RO mask index for group B can be signaled in the RA configuration. In these embodiments, the RO mask index for group A indicates which ROs of SSB are for group A, and the remaining ROs of SSB are for group B.

In some embodiments, the RO mask index for group B can be signaled in the RA configuration. In these embodiments, RO mask index for group B indicates which ROs of SSB are for group B, and the remaining ROs of SSB are for group A.

In some embodiments for signaling RO groups A, B and C, an RO mask index can be signaled.

In some embodiments, the RO mask index for group A, RO mask index for group B, and RO mask index for group C can be signaled in the RA configuration. In these embodiments, the RO mask index for group A indicates which ROs of SSB are for group A, the RO mask index for group B indicates which ROs of SSB are for group B, and the RO mask index for group C indicates which ROs of SSB are for group C.

In some embodiments, the RO mask index for group A and RO mask index for group B can be signaled in the RA configuration. The RO mask index for group A indicates which ROs of SSB are for group A, the RO mask index for group B indicates which ROs of SSB are for group B, and the remaining ROs of SSB are for group C.

In some embodiments, the RO mask index for group A and the RO mask index for group C can be signaled in the RA configuration. In these embodiments, the RO mask index for group A indicates which ROs of SSB are for group A, the. RO mask index for group C indicates which ROs of SSB are for group C, and the remaining ROs of SSB are for group B.

In some embodiments, the RO mask index for group B and the RO mask index for group C can be signaled in the RA configuration. The RO mask index for group B indicates which ROs of SSB are for group B, the RO mask index for group C indicates which ROs of SSB are for group C, and the remaining ROs of SSB are for group A.

In some embodiments for signaling RO groups, a different PRACH configuration index can be signaled for each RO group. In these embodiments, during RA procedure, the UE determines the ROs based on the PRACH configuration index corresponding to selected RO group.

In some embodiments for signaling RO groups, a different RA configuration for a different group can be signaled. In these embodiments, during RA procedure (or at initiation of RA procedure), the UE selects the RA configuration based on the selected RO group.

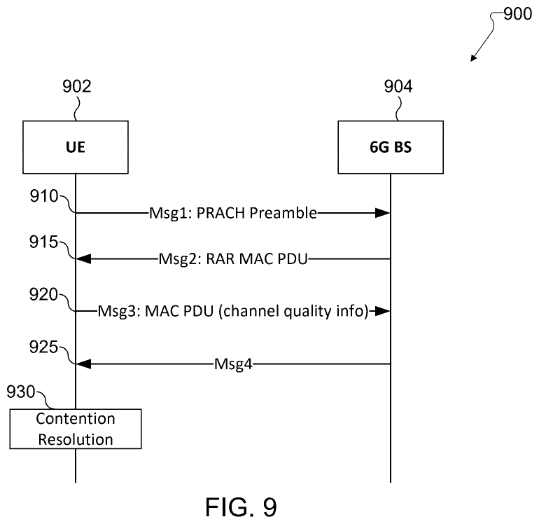

FIG. 10 illustrates an example method 1000 for random access according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for random access could be used without departing from the scope of this disclosure.

In the example of FIG. 10, method 1000 begins at step 1010. At step 1010, a UE (such as UE 116 of FIG. 1) receives, from a BS (such as gNB 102 of FIG. 1), a plurality of RA resource configurations.

At step 1020, the UE initiates an RA procedure.

At step 1030, the UE selects an RA resource configuration from the plurality of RA resource configurations for the RA procedure.

At step 1040, the UE transmits an indication of the selected RA resource configuration to the BS.

At step 1050, the UE performs the RA procedure based on the selected RA resource configuration.

In some embodiments, the UE may receive, from the BS, an acknowledgement (ACK) for the indication of the selected RA resource configuration. In these embodiments, the UE may perform the RA procedure based on the selected RA resource configuration in response to receiving the ACK.

In some embodiments, the UE may receive, from the BS, a configuration indicating resources to indicate the selected RA resource configuration to the BS. In these embodiments, the UE may transmit the indication of the selected RA resource configuration to the BS in response to receiving the configuration indicating resources to indicate the selected RA resource configuration to the BS.

In some embodiments, the UE may receive, from the BS, an indication for the UE to transmit the indication of the selected RA resource configuration to the BS. In these embodiments, the UE may transmit the selected RA resource configuration to the BS in response to receiving the indication for the UE to transmit the indication of the selected RA resource configuration to the BS.

In some embodiments, a resource to indicate the selected RA resource configuration to the BS is at least one of (i) an RA preamble, (ii) an RO), (iii) one or more PUSCH resources, and (iv) one or more PUCCH resources. In some embodiments, the RA preamble and the RO may be configured from RA preambles and ROs of the selected RA resource configuration. In some embodiments, the RA preamble and the RO may be configured from RA preambles and ROs of the selected RA resource configuration not associated with any feature.

Although FIG. 10 illustrates one example method 1000 for random access, various changes may be made to FIG. 10. For example, while shown as a series of steps, various steps in FIG. 10 could overlap, occur in parallel, occur in a different order, occur any number of times, be omitted, or replaced by other steps.

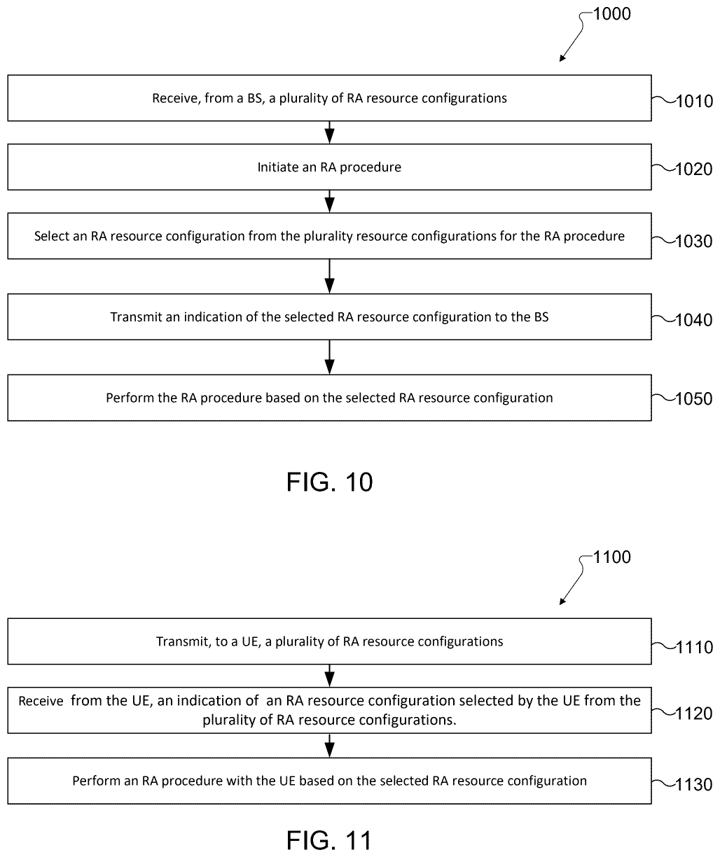

FIG. 11 illustrates an example method 1100 for random access according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for random access could be used without departing from the scope of this disclosure.

In the example of FIG. 11, method 1100 begins at step 1110. At step 1110, a BS (such as gNB 102 of FIG. 1) transmits, to a UE (such as UE 116 of FIG. 1), a plurality of RA resource configurations.

At step 1120 the BS receives, from the UE, an indication of an RA resource configuration selected by the UE from the plurality of RA resource configurations. In some embodiments, prior to the BS receiving the indication of the selected RA resource configuration, the BS may transmit, to the UE, a configuration indicating resources to indicate the selected RA resource configuration to the BS. In some embodiments, prior to the BS receiving the indication of the selected RA resource configuration, the BS may transmit, to the UE, an indication for the UE to transmit the indication of the selected RA resource configuration to the BS. In some embodiments, in response to receiving the indication of the selected RA resource configuration, the BS may transmit an ACK for the indication of the selected RA resource configuration.

At step 1130, the BS performs an RA procedure with the UE based on the selected RA resource configuration.

In some embodiments, a resource to indicate the selected RA resource configuration to the BS is at least one of (i) an RA preamble, (ii) an RO), (iii) one or more PUSCH resources, and (iv) one or more PUCCH resources. In some embodiments, the RA preamble and the RO may be configured from RA preambles and ROs of the selected RA resource configuration. In some embodiments, the RA preamble and the RO may be configured from RA preambles and ROs of the selected RA resource configuration not associated with any feature.

Although FIG. 11 illustrates one example method 1100 for random access, various changes may be made to FIG. 11. For example, while shown as a series of steps, various steps in FIG. 11 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a base station (BS), a plurality of random access (RA) resource configurations; and
a processor operably coupled to the transceiver, the processor configured to:
initiate an RA procedure;
select an RA resource configuration from the plurality of RA resource configurations for the RA procedure;
cause the transceiver to transmit an indication of the selected RA resource configuration to the BS; and
after causing the transceiver to transmit the indication of the selected RA resource configuration to the BS, perform the RA procedure based on the selected RA resource configuration.

2. The UE of claim 1, wherein:
the transceiver is further configured to receive, from the BS, an acknowledgment (ACK) for the indication of the selected RA resource configuration; and
the processor is further configured to perform the RA procedure based on the selected RA resource configuration in response to the transceiver receiving the ACK.

3. The UE of claim 1, wherein:
the transceiver is further configured to receive, from the BS, a configuration indicating resources to indicate the selected RA resource configuration to the BS; and
the processor is further configured to cause the transceiver to transmit the indication of the selected RA resource configuration to the BS in response to the transceiver receiving the configuration indicating resources to indicate the selected RA resource configuration to the BS.

4. The UE of claim 1, wherein:
the transceiver is further configured to receive, from the BS, an indication for the UE to transmit the indication of the selected RA resource configuration to the BS; and
the processor is further configured to cause the transceiver to transmit the indication of the selected RA resource configuration to the BS in response to the transceiver receiving the indication for the UE to transmit the indication of the selected RA resource configuration to the BS.

5. The UE of claim 1, wherein a resource to indicate the selected RA resource configuration to the BS is at least one of:
an RA preamble;
an RA occasion (RO);
one or more physical uplink shared channel (PUSCH) resources; and
one or more physical uplink control channel (PUCCH) resources.

6. The UE of claim 5, wherein the RA preamble and the RO are configured from RA preambles and ROs of the selected RA resource configuration.

7. The UE of claim 5, wherein the RA preamble and the RO are configured from RA preambles and ROs of the selected RA resource configuration not associated with any feature.

8. A base station (BS) comprising:
a transceiver configured to:
transmit, to a user equipment (UE), a plurality of random access (RA) resource configurations; and
receives, from the UE, an indication of an RA resource configuration selected by the UE from the plurality of RA resource configurations; and
a processor operatively coupled to the transceiver, the processor configured to, after receiving the indication of the selected RA resource configuration from the UE, perform an RA procedure with the UE based on the selected RA resource configuration.

9. The BS of claim 8, wherein the transceiver is further configured to transmit, to the UE, an acknowledgment (ACK) for the indication of the selected RA resource configuration.

10. The BS of claim 8, wherein:
the transceiver is further configured to transmit, to the UE, a configuration indicating resources to indicate the selected RA resource configuration to the BS.

11. The BS of claim 8, wherein:
the transceiver is further configured to transmit, to the UE, an indication for the UE to transmit the indication of the selected RA resource configuration to the BS.

12. The BS of claim 8, wherein a resource to indicate the selected RA resource configuration to the BS is at least one of:
an RA preamble;
an RA occasion (RO);
one or more physical uplink shared channel (PUSCH) resources; and
one or more physical uplink control channel (PUCCH) resources.

13. The BS of claim 12, wherein the RA preamble and the RO are configured from RA preambles and ROs of the selected RA resource configuration.

14. A method of operation a user equipment (UE), the method comprising:
receiving, from a base station (BS), a plurality of random access (RA) resource configurations;
initiating an RA procedure;
selecting an RA resource configuration from the plurality of RA resource configurations for the RA procedure;
transmitting an indication of the selected RA resource configuration to the BS; and
after transmitting the indication of the selected RA resource configuration to the BS, performing the RA procedure based on the selected RA resource configuration.

15. The method of claim 14, further comprising:
receiving, from the BS, an acknowledgment (ACK) for the indication of the selected RA resource configuration,
wherein the RA procedure based on the selected RA resource configuration is performed in response to receiving the ACK.

16. The method of claim 14, further comprising:
receiving, from the BS, a configuration indicating resources to indicate the selected RA resource configuration to the BS,
wherein the indication of the selected RA resource configuration is transmitted to the BS in response to receiving the configuration indicating resources to indicate the selected RA resource configuration to the BS.

17. The method of claim 14, further comprising:
receiving, from the BS, an indication for the UE to transmit the indication of the selected RA resource configuration to the BS,
wherein the selected RA resource configuration is transmitted to the BS in response to receiving the indication for the UE to transmit the indication of the selected RA resource configuration to the BS.

18. The method of claim 14, wherein a resource to indicate the selected RA resource configuration to the BS is at least one of:
an RA preamble;
an RA occasion (RO);
one or more physical uplink shared channel (PUSCH) resources; and
one or more physical uplink control channel (PUCCH) resources.

19. The method of claim 18, wherein the RA preamble and the RO are configured from RA preambles and ROs of the selected RA resource configuration.

20. The method of claim 18, wherein the RA preamble and the RO are configured from RA preambles and ROs of the selected RA resource configuration not associated with any feature.
